(19) United States
(12) Patent Application Publication
(10) Pub. No.: US 2016/0105145 A1
(43) Pub. Date: Apr. 14, 2016

(54) System and Method for Transparent Solar Panels

(71) Applicant: Kenneth C. Drake, Heber, UT (US)

(72) Inventor: Kenneth C. Drake, Heber, UT (US)

(21) Appl. No.: 14/972,491

(22) Filed: Dec. 17, 2015

Related U.S. Application Data
(63) Continuation-in-part of application No. 13/303,360, filed on Nov. 23, 2011.
Application No. 13/303,360 is a continuation-in-part of application No. 13/008,652, filed on Jan. 18, 2011.
(60) Provisional application No. 61/295,842, filed on Jan. 18, 2010.

(51) Int. Cl. H02S 20/25; H02S 40/40; H02S 50/00

(52) U.S. Cl. CPC H02S 20/25; H02S 50/00; H02S 40/40

(57) ABSTRACT

An apparatus includes a transparent photovoltaic cell, a roof decoration located under and viewable through the transparent photovoltaic cell, and a mounting frame sized to receive said photovoltaic cell and the roof decoration. The mounting frame is configured to be securely fastened to a roof of a structure.

### RELATED APPLICATIONS

This application is a Continuation-In-Part application of U.S. patent application Ser. No. 13/303,360, filed Nov. 23, 2011 and titled “System and Method for Forming Roofing Solar Panels. U.S. patent application Ser. No. 13/303,360 is a Continuation-In-Part application of U.S. patent application. Ser. No. 13/008,652, filed Jan. 18, 2011 and titled “System and Method for Forming Roofing Solar Panels,” which application claims the benefit under 35 U.S.C. §119(e) of U.S. Provisional Patent Application No. 61/295,842 filed Jan. 18, 2010 titled “System and Method for Forming Roofing Solar Panels,” which applications are incorporated herein by reference in their entireties.

### BACKGROUND

In recent years, societal consciousness of the problems relating to the environment and energy has been increasing throughout the world. Particularly, heating of the earth because of the so-called greenhouse effect due to an increase of atmospheric CO₂ has been predicted to cause serious problems. In view of this, there is an increased demand for means of power generation capable of providing clean energy without causing CO₂ build-up. In this regard, nuclear power generation has been considered advantageous in that it does not cause CO₂ build-up. However, there are problems with nuclear power generation such that it unavoidably produces radioactive wastes which are harmful for living things, and there is a probability that leakage of injurious radioactive materials from the nuclear power generation system will occur when the system is damaged. Consequently, there is an increased societal demand for early realization of a power generation system capable of providing clean energy without causing CO₂ build-up as in the case of thermal power generation and without causing radioactive wastes and radioactive materials as in the case of nuclear power generation.

There have been various proposals which are expected to meet such societal demand. Among those proposals, solar cells (i.e., photovoltaic elements) are expected to be a future power generation source since they supply electric power without causing the above mentioned problems and they are safe and can be readily handled. Particularly, public attention has been focused on a solar cell power generation system because it is a clean power generation system which generates electric power using sunlight. It is also evenly accessible at any place in the world and can attain relatively high power generation efficiency without requiring a relatively complicated large installation. Additionally, the use of solar cell power generation systems can also be expected to comply with an increase in the demand for electric power in the future without causing environmental destruction.

Incidentally, solar cells have been gaining in popularity since they are clean and non-exhaustible electric power sources. Additionally, a number of technological advances have been made that both improve the performance and ease of manufacturing the solar cells. These advances have resulted in the expansion of solar cells to an increasing number of homes and buildings.

In the case of installing a plurality of solar cell modules on a roof of a building, the process typically involves the placement of a predetermined number of the solar cell modules on independent structures on the roof. The solar cell module herein means a structural body formed by providing a plurality of solar cells, electrically connecting them to each other in series connection or parallel connection to obtain a solar cell array, and sealing said array into a panel-like shape. In the case of installing these solar cell modules on the roof, they are spacedly arranged on the roof at equal intervals, followed by electrically wiring them so that they are electrically connected with each other in series connection or parallel connection. The result of this process is generally called a solar cell module array. Traditional solar cell module arrays are placed on structural panels that are mechanically attached to a rack that is spaced from the roof and is connected to the roof by fixing fasteners through the shingles, felt, and structural building material of a roof. The passing of mechanical fasteners through the elemental barrier layer of the roof generates a potential weak spot in the environmental barrier of the roof and may result in leaks or other environmental issues.

### SUMMARY

An exemplary system and method for forming a solar panel system includes manufacturing solar panel sheets via thin film solar technology that include a flashing overlap and a non-dry adhesive located on the bottom surface of the sheets such that the solar panel sheets form a moisture barrier on the roof while providing a renewable solar energy source.

In another exemplary embodiment, the solar panel system that forms a moisture barrier on the roof of a structure includes a non-glare surface treatment to provide the appearance of standard 30 year shingles. Additionally, in another exemplary embodiment, the solar panel system includes a temperature/pressure/light transmissibility sensor system configured to notify a homeowner when the solar panel system is dirty, obscured, or should be changed to reverse current mode to melt snow or ice buildup.

In yet another example, an apparatus includes a transparent photovoltaic cell, a roof decoration located under and viewable through the transparent photovoltaic cell, and a mounting frame sized to receive said photovoltaic cell and the roof decoration. The mounting frame is configured to be securely fastened to a roof of a structure.

In some cases, the roof decoration resembles tile, roof shingles, thatching, another roof material, or combinations thereof. Further, the photovoltaic cell may include a gauge sensor. The gauge sensor measures an amount of snow on the transparent photovoltaic cell. The apparatus may also include a heating system that melts snow on the transparent photovoltaic cell in respond to a measurement obtained with the gauge sensor.

The mounting frame may include a base, a plurality of side walls coupled to said base and extending vertically from said base, and a plurality of support structures formed on said base, said plurality of support structures being configured to support said photovoltaic cell above said base. The plurality of support structures define at least one vent channel configured to direct air beneath said photovoltaic cell. The photovoltaic cell may include a plurality of leads coupled to the photovoltaic cell where the leads are disposed in said at least one vent channel when said apparatus is assembled. The apparatus may also include a wall coupler disposed on a top surface of said plurality of sidewalls to seal adjacent side walls. The apparatus may include a plurality of support structures formed on said base comprise a rectangular cross-section. The apparatus may include that the plurality of support structures formed on said base comprise a circular cross-section.

In another embodiment, an apparatus includes a first transparent photovoltaic cell, a second transparent photovoltaic cell adjacent to and abutted against the first transparent photovoltaic cell forming a junction between the first transparent photovoltaic cell and the transparent photovoltaic cell, a sealing material disposed within the junction, a roof decoration located under and viewable through at least one of the first transparent photovoltaic cell and the second transparent photovoltaic cell, a mounting frame sized to receive said photovoltaic cell, wherein said mounting frame further includes a base, a plurality of side walls coupled to said base and extending vertically from said base, and a plurality of support structures formed on said base, said plurality of support structures being configured to support said photovoltaic cell above said base. The plurality of support structures define at least one vent channel configured to direct air beneath said photovoltaic cell, and the mounting frame is configured to be securely fastened directly to a roof of a structure and form a vapor barrier on said roof.

A non-photovoltaic spacer may be adjacent to and abutted against another side of at least one of the first transparent photovoltaic cell and second transparent photovoltaic cell, wherein the non-photovoltaic spacer comprises a lower melting temperature than the first transparent photovoltaic cell. The non-photovoltaic spacer may be positioned over a ridge of the roof. The photovoltaic cell may also include a gauge sensor. The gauge sensor may measure an amount of snow on the transparent photovoltaic cell. The apparatus may include a heating system that melts snow on the transparent photovoltaic cell in respond to a measurement obtained with the gauge sensor.

In yet another example, an apparatus may include a first transparent photovoltaic cell, a second transparent photovoltaic cell adjacent to and abutted against the first transparent photovoltaic cell forming a junction between the first transparent photovoltaic cell and the transparent photovoltaic cell, a sealing material disposed within the junction, a roof decoration located under and viewable through at least one of the first transparent photovoltaic cell and the second transparent photovoltaic cell, a mounting frame sized to receive said photovoltaic cell, wherein said mounting frame further includes a base, a plurality of side walls coupled to said base and extending vertically from said base, and a plurality of support structures formed on said base, said plurality of support structures being configured to support said photovoltaic cell above said base, a non-photovoltaic spacer is adjacent to and abutted against another side of at least one of the first transparent photovoltaic cell and second transparent photovoltaic cell, wherein the non-photovoltaic spacer comprises a lower melting temperature than the first transparent photovoltaic cell, the non-photovoltaic spacer is positioned over a ridge of the roof, the photovoltaic cell further comprises a gauge sensor, the gauge sensor measures an amount of snow on the transparent photovoltaic cell, and a heating system that melts snow on the transparent photovoltaic cell in respond to a measurement obtained with the gauge sensor. The plurality of support structures define at least one vent channel configured to direct air beneath said photovoltaic cell, and the mounting frame is configured to be securely fastened directly to a roof of a structure and form a vapor barrier on said roof.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 illustrates a solar panel system incorporated onto the roof of a house, according to one exemplary embodiment.

FIG. 2 illustrates a top view of a photovoltaic cell that can form the vapor barrier of a roofing system, according to one exemplary embodiment.

FIG. 3 illustrates a bottom view of a photovoltaic cell that can form the vapor barrier of a roofing system, according to one exemplary embodiment.

FIG. 4 illustrates a bottom cross-sectional view of a photovoltaic cell that can form the vapor barrier of a roofing system, according to one exemplary embodiment.

FIG. 5 illustrates a side cross-sectional view of a photovoltaic cell that can form the vapor barrier of a roofing system, according to one exemplary embodiment.

FIG. 6 is a side cross-sectional view illustrating the placement of the present solar panel system on the roof of a structure, according to one exemplary embodiment.

FIG. 7 is a side cross-sectional view illustrating the placement of the present solar panel system on the roof of a structure, according to another exemplary embodiment.

FIG. 8 is a side view of a solar panel placement structure, according to one exemplary embodiment.

FIG. 9 is a cross-sectional view of a photovoltaic cell that can be secured in the structure of FIG. 8, according to one exemplary embodiment.

FIG. 10 is a perspective view of a vent sheet, according to one exemplary embodiment.

FIG. 11 is an exploded view of a vent sheet and solar panel assembly, according to one exemplary embodiment.

FIGS. 12A and 12B illustrate a perspective and cross-sectional view of the assembled solar panel placement structure of FIG. 8, according to one exemplary embodiment.

FIGS. 13A and 13B illustrate a perspective and front view, respectively, of assembled vent sheets, according to one exemplary embodiment.

FIG. 14 illustrates a perspective view of a solar panel system incorporated onto the roof of a house, according to one exemplary embodiment.

FIG. 15 illustrates a side view of a solar panel system incorporated onto the roof of a house, according to one exemplary embodiment.

Throughout the drawings, identical reference numbers designate similar, but not necessarily identical, elements.

### DETAILED DESCRIPTION

An exemplary system and method for forming a solar panel system is disclosed herein. Specifically, An exemplary system and method for forming a solar panel system includes manufacturing solar panel sheets via thin film solar technology or other photovoltaic cell forming process that include a flashing overlap and a non-dry adhesive located on the bottom surface of the sheets such that the solar panel sheets form a moisture barrier on the roof while providing a renewable solar energy source. According to one exemplary embodiment, the solar panel system that forms a moisture barrier on the roof of a structure includes a non-glare surface treatment to provide the appearance of standard 30 year shingles. Additionally, in another exemplary embodiment, the solar panel system includes a sensor temperature/pressure/light transmissibility system configured to notify a homeowner when the solar panel system is dirty, obscured, or should be changed to reverse current mode to melt snow or ice buildup. Embodiments and examples of the present exemplary systems and methods will be described in detail below.

The sensor may be a temperature sensor, a pressure sensor, a light transmissibility sensor, another type of sensor, or combinations thereof. In one example, the sensor is an optical sensor that detects the depth of snow accumulated on the photovoltaic cells. This optical sensor may be a gauge that is positioned on the photovoltaic cell that includes a lens. As a snow depth increases, the snow depth prevents light from entering the lens. In some cases, the reduction of light is interpreted by the sensor to indicate that there is an amount of snow on the photovoltaic cell. In some cases, the sensor is in communication with a calendar so that the sensor understands whether or not the time of year is in a season where snow is likely. In other examples, the optical sensor is in communication with a temperature sensor that senses either the temperature of the ambient air around the photovoltaic cell or the temperature of the photovoltaic cell itself. In other examples, a pressure sensor may be used in conjunction with the optical sensor so that a pressure indicating the amount of weight on the photovoltaic cell measured with the pressure sensor and the optical sensor collectively provide information that is used to determine that a snow load is covering the photovoltaic surface.

In those circumstances where snow is determined to be covering the surface of the photovoltaic cell, heat may be applied to the surface of the photovoltaic cell to cause the snow to melt. In some cases, the current of the photovoltaic cells may reverse to generate heat in the cells that cases the snow to melt. In other examples, an independent circuit may be used to generate heat that causes the snow to melt.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure.

Additionally, as used herein, and in the appended claims, the term “photovoltaic cell” shall be understood to mean any member or construct that is configured to produce a voltage when exposed to radiant energy.

As used herein, the terms “conductor”, “conducting”, or “conductive” are meant to be understood as any material which offers low resistance or opposition to the flow of electric current due to high mobility and high carrier concentration.

In the following description, for purposes of explanation, numerous specific details are set forth in order to provide a thorough understanding of the present system and method for forming a solar panel system. It will be apparent, however, to one skilled in the art, that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

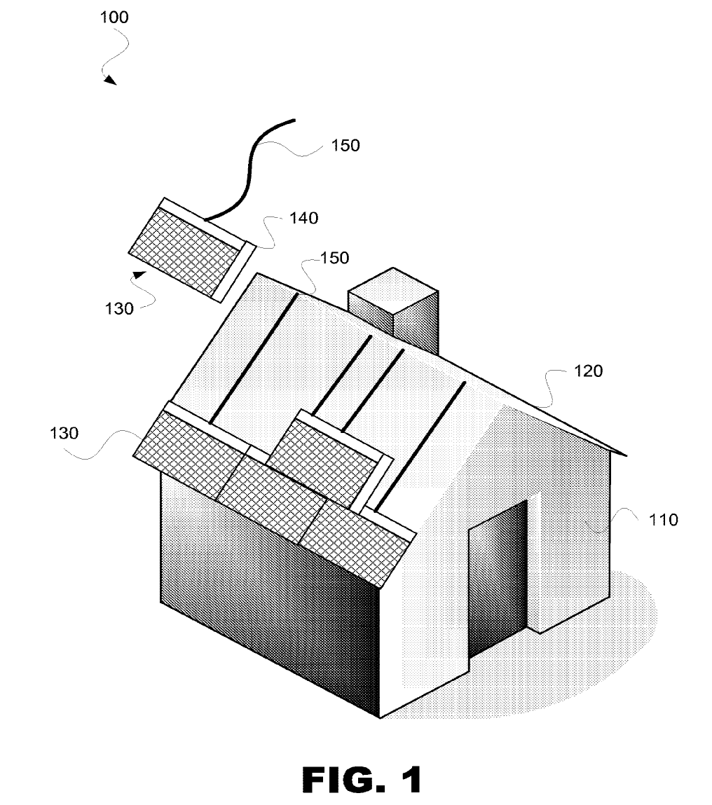

FIG. 1 illustrates a solar panel system incorporated onto the roof of a house, according to one exemplary embodiment. As illustrated in FIG. 1, the exemplary solar panel system (100) is configured to be fastened to the roof (120) of a house (110) or other structure. According to one exemplary embodiment, the solar panel system (100) includes a plurality of panels (130) formed with a flashing member (140) formed on the distal end thereof including a pigtail or other electric lead (150) protruding from the distal end of the panel (130). Additionally, according to one exemplary embodiment illustrated in FIG. 1, the exemplary panel (130) includes a flashing member (140) located on a side portion of the panel. This allows for a flashing member to be present on all abutting seams as the panels are fastened to a surface, as will be described in further detail below.

As shown in FIG. 1, a plurality of panels (130) are securely fastened to the roof (120) portion of the house (110) or other structure and not only provide the ability to generate electricity via exposure to the sun, but also provides the function and appearance of a moisture barrier such as a shingle. Further details of the exemplary structure and function of the exemplary panel (130) and its incorporation into the exemplary solar panel system (100) will be provided below.

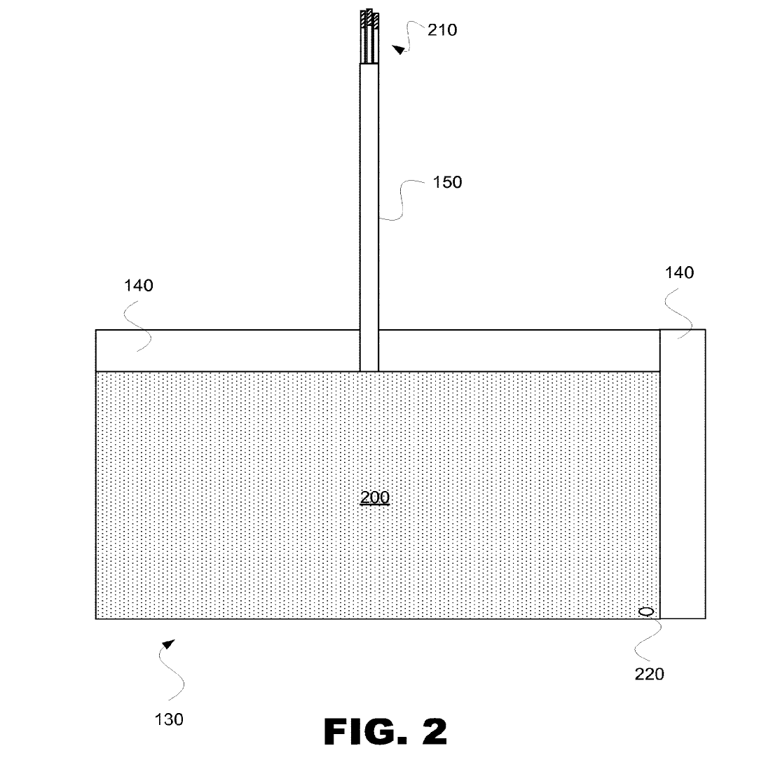

FIG. 2 illustrates a top view of a photovoltaic cell that can form the vapor barrier of a roofing system, according to one exemplary embodiment. While the exemplary photovoltaic cell (200) of FIG. 2 is illustrated as rectangular in shape, it will be understood that the exemplary photovoltaic cell (200) may assume any number of shapes and or shape combinations in order to adequately cover the roof of a house or other building. According to one exemplary embodiment, the exemplary photovoltaic cell is manufactured to custom fit the dimensions of a roof by the manufacturer and shipped to the home site for installation. According to this exemplary embodiment, the roofing contractor measures the dimensions of the roof to be worked upon and provides the dimensions to the manufacturing facility for custom manufacture. Additionally, according to one exemplary embodiment, the exemplary photovoltaic cell (200) may be dimensioned to be integrated with traditional shingles, if desired.

Continuing with FIG. 2, the exemplary panel (130) includes a photovoltaic cell (200) configured to produce a voltage when exposed to radiant energy, such as sunlight. According to one exemplary embodiment, the photovoltaic cell may be any one of a single crystal silicon cell, a polycrystal silicon cell, a ribbon silicon cell, and/or an amorphous silicon cell. As illustrated, a flashing (140) configured to provide a vapor proof barrier when inter-lockingly placed on the roof of a home or building is formed on the distal, or up-pitch side of the exemplary panel (130). Additionally, an exemplary flashing (140) is formed on the right side, as viewed from the top in FIG. 2, of the exemplary panel (130). While the side flashing member (140) is described as being on the right side, the side flashing member may be on either or both sides, depending on the intended application of the system. According to one exemplary embodiment, the flashing is formed using traditional shingle flashing material, including, but in no way limited to, sheet metals such as aluminum, copper, lead-coated copper, lead, stainless steel, galvanized steel, zinc, and Galvalume or membrane flashings including but in no way limited to any one of a polymer based film, polyester film, fibrous glass mesh sheets, and/or a resinous adhesive.

At the distal end of the panel (130), a pigtail or electrical lead (150) exits the photovoltaic cell (200). According to one exemplary embodiment, the pigtail or electrical lead (150) includes a number of conductors (210) enclosed therein. The pigtail or electrical lead (150) is configured to form a conduit for any electricity generated by the photovoltaic cell (200) and channel the generated electricity to a bank of batteries, the grid, or another power storage/distribution member (not shown). According to one exemplary embodiment, the pigtail or electrical lead (150) is disposed on top of the flashing (140) such that the flashing may form a complete seal on the roof of the structure it is fastened to in order to form a vapor barrier thereon.

Additionally, as illustrated in FIG. 2, the exemplary panel (130) may also include a sensor (220) for sensing light, temperature and/or pressure. For example, according to one exemplary embodiment, the sensor (220) may be a piezoelectric crystal based sensor configured to detect weight on the panel (130). According to one embodiment, when the sensor detects weight on the panel (130), it may notify a monitoring system and alert the homeowner to check for snow, leaves, or other debris. In another exemplary embodiment, the sensor may be a temperature sensor configured to notify the home owner when snow and/or ice are likely to cover the panel and prevent or deteriorate the panel's ability to produce electricity. In this embodiment, when the sensor detects a low temperature, the panel (130) may be configured to reverse the current and create a thermal effect within the photovoltaic cell (200) to melt any ice and/or snow that may be on the panel (130). According to yet another exemplary embodiment, the panel (130) may include a light sensor configured to notify the user when the generation of electricity is not possible so that the user can investigate any reason for such a condition.

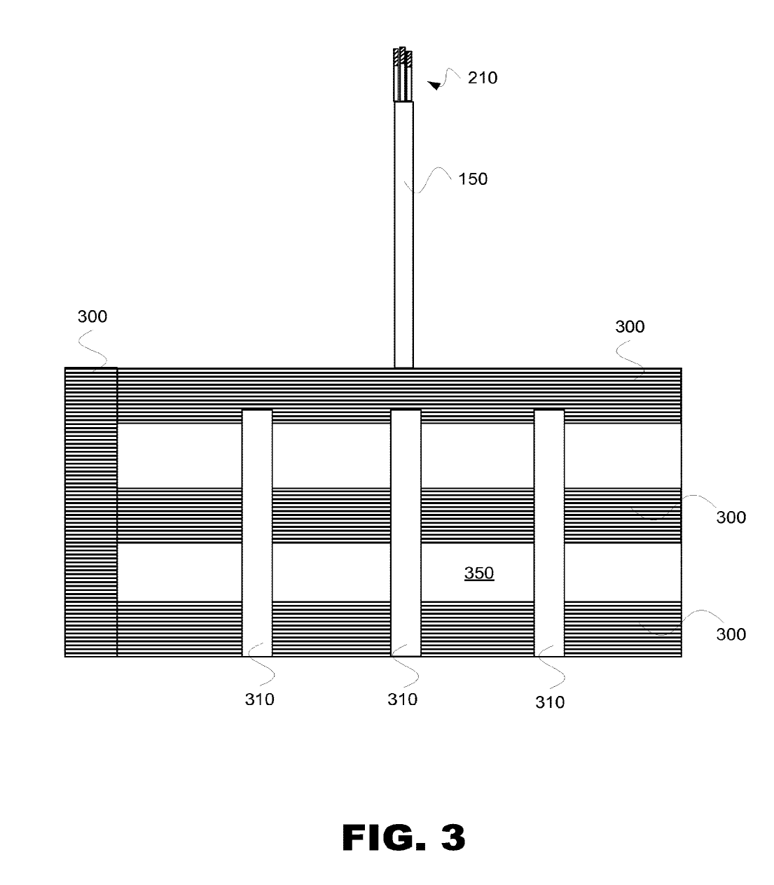

FIG. 3 illustrates a bottom view of a photovoltaic cell that can form the vapor barrier of a roofing system, according to one exemplary embodiment. As illustrated in FIG. 3, the bottom surface of the exemplary panel (130) includes a back surface (350) having a number of adhesive strips (300) horizontally positioned on the back surface of the panel. A vertical adhesive strip (300) is also located on the side flashing member (140). According to one exemplary embodiment, the adhesive strips (300) are formed of a non-hardening adhesive material, such as tar or other adhesive materials, and is configured to have a barrier layer removed and the adhesive to be affixed to the roof of a house or other building. According to one exemplary embodiment illustrated in FIG. 3, a plurality of adhesive strips (300) may be formed on the back surface (350) of the panel (130) in order to prevent bending of the panel in the event of high winds or other extreme weather conditions. The plurality off adhesive strips (300) also prevents the insertion of debris and/or pests under the panel (130). According to the exemplary embodiment shown in FIG. 3, three horizontal swaths of the adhesive strips (300) are present on the back surface (350) of the panel (130). However, any number of adhesive strips (300) may be formed on the back surface (350) of the panel (130).

Additionally, as illustrated in FIG. 3, a number of gaps or lead channels (310) are alternatively formed in the adhesive strips (300). According to one exemplary embodiment, the lead channels (310) are configured to receive the pigtail or electrical lead (150) of other panels (130) and provide a channel or conduit for the electrical leads (150) of other panels to traverse on their route to the top of the roof. According to this exemplary embodiment, the lead channel (310) is formed as vertical sections of the back surface (350) without any adhesive (300) or other structural material, allowing for the free flow and expansion/contraction of the electrical leads (150) of other panels (130). According to the exemplary embodiment illustrated in FIG. 3, three lead channels (310) are provided in order to allow a quarterly offset of the panels (130) being placed on a roof. However, any number of lead channels (310) may be formed.

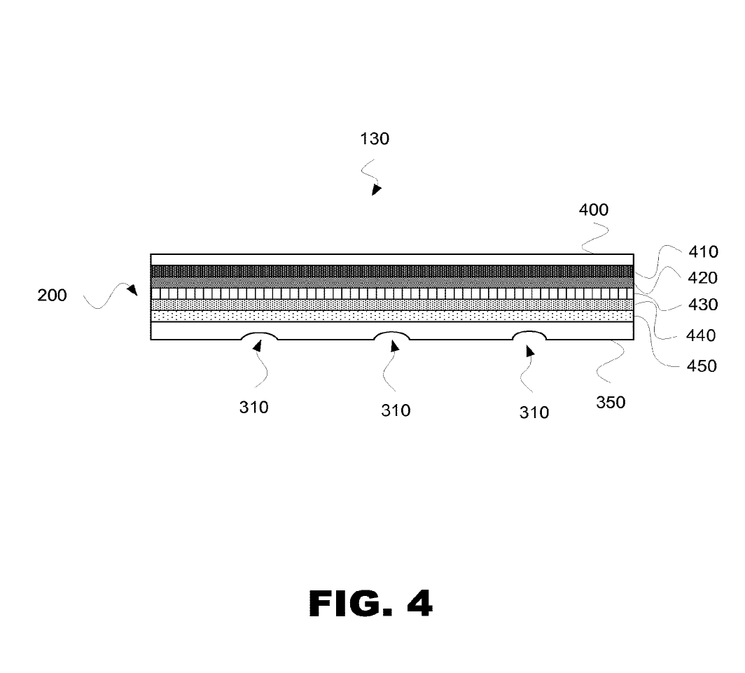

FIG. 4 illustrates a bottom cross-sectional view of a photovoltaic cell that can form the vapor barrier of a roofing system, according to one exemplary embodiment. As illustrated in FIG. 4, the panel (130) includes a photovoltaic cell (200) that is built upon a back surface (350). As illustrated, the back surface is formed such that a plurality of lead channels (310) are formed to allow for the vertical running of electrical leads (150) from the bottom panels (130) to the top ridge of the house for collection.

On top of the back surface (350) is the plurality of layers that form the photovoltaic cell (200). According to one exemplary embodiment illustrated in FIG. 4, the photovoltaic cell (200) includes, but is in no way limited to a semiconductor having a back contact (450), a p-type semiconductor (440), an n-type semiconductor (430), a contact grid (420), an anti-reflective coating (410), and a cover glass substrate (400). According to one exemplary embodiment, the p-type semiconductor (440) and the n-type semiconductor (430) are separated by a P-N junction absorber layer (not shown).

According to the exemplary embodiment illustrated in FIG. 4, When the holes and electrons mix at the junction between N-type and P-type silicon, neutrality is disrupted and free electrons on the N-type semiconductor (430) cross to the p-type semiconductor (440) until an electric field separating the two sides. This electric field acts as a diode, allowing (and even pushing) electrons to flow from the P-type semiconductor (440) to the N-type semiconductor (430) creating an electric field acting as a diode in which electrons can only move in one direction.

When light, in the form of photons, hits the photovoltaic cell (200), its energy frees electron-hole pairs. Each photon with enough energy will normally free exactly one electron, and result in a free hole as well. If this happens close enough to the electric field, or if free electron and free hole happen to wander into its range of influence, the field will send the electron to the N-type semiconductor (430) and the hole to the P-type semiconductor (440). This causes further disruption of electrical neutrality, and if we provide an external current path, electrons will flow through the path to their original side, the P-type semiconductor (440), to unite with holes that the electric field sent there, doing work along the way. The electron flow provides the current, and the cell's electric field causes a voltage. With both current and voltage, power is produced.

The back contact (450) and the contact grid (420) are formed to capture the power and transmit it, via the electrical leads (150) to a power storage location (not shown). Additionally, as silicon is a very shiny material, it is very reflective. Since photons that are reflected can't be used by the cell, the antireflective coating (410) is applied to the top of the photovoltaic cell (200) to reduce reflection losses. Additionally, the cover glass (400) is placed on the top if the photovoltaic cell (200) in order to protect the cell from the elements. According to one exemplary embodiment, the cover glass (400) is processed such that its top view of the panel (130) is substantially similar to a traditional 30 year asphalt shingle. As used herein, the term “cover glass” shall be interpreted broadly to include any number of substantially transparent materials suitable for covering and/or encasing the photovoltaic cell (200) including, but in no way limited to, silica based glass, traditional glass, polymers, and the like.

The asphalt shingle appearance may be provided to the cover glass (400) via any number of surface treatment methods including, but in no way limited to, etching, painting, and the like. Once constructed, a plurality of panels (130) including photovoltaic cells (200) are placed in series and parallel to achieve useful levels of voltage and current that is transmitted through the electrical lead (150).

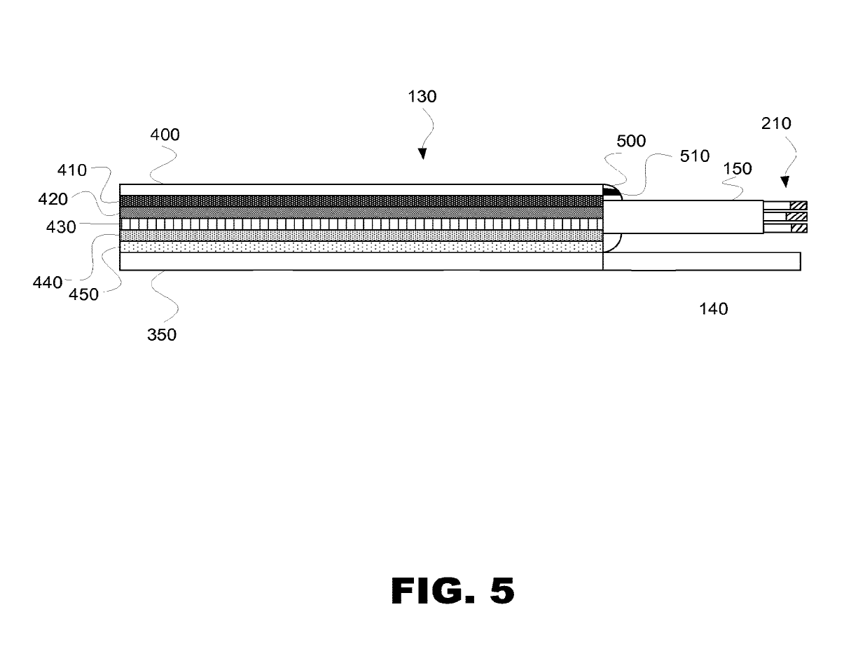

FIG. 5 illustrates another side cross-sectional view of a photovoltaic cell that can form the vapor barrier of a roofing system, according to one exemplary embodiment. As illustrated in FIG. 5, the vertically placed lead channels (310) are not seen traversing the back surface (350). However, as shown, a flashing member (140) is coupled to the back surface (350) in order to allow the exemplary panel system (130) to serve as a shingle/water barrier for a roof. According to one exemplary embodiment, the flashing member (140) may be formed of the same material as the back surface (350) and merely extend beyond the termination of the panel (130). Alternatively, the flashing (140) may be coupled to the back surface by an adhesive, mechanical coupling, or any other fastening means.

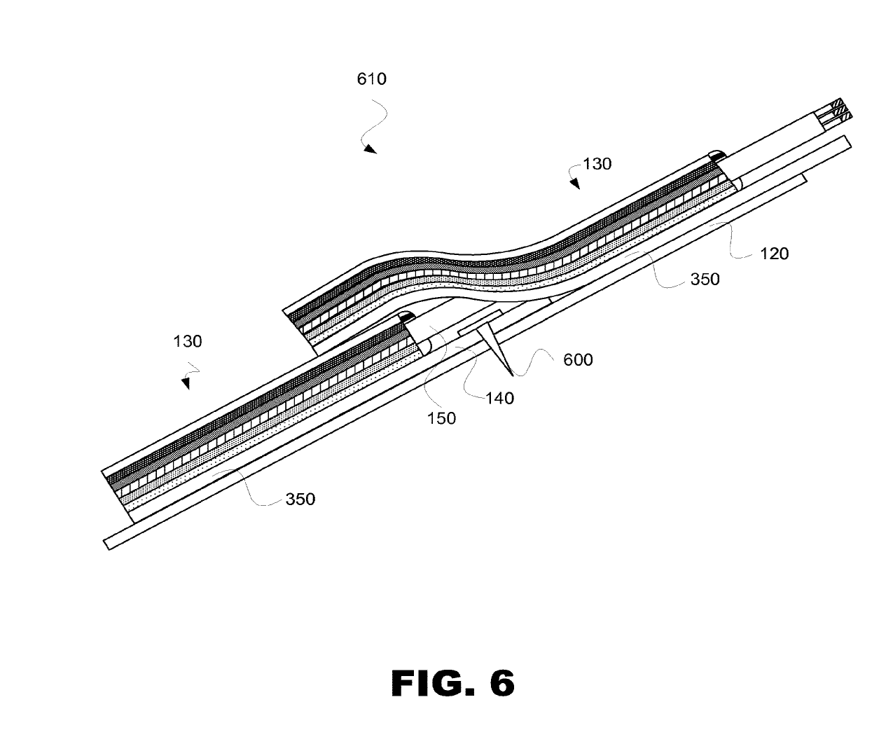

FIG. 5 also illustrates the coupling of the electrical lead (150) including conductors (210) to the photovoltaic cell (200), according to one exemplary embodiment. As shown, the conductors (210) may be coupled to one or more of the back contact (450) and the contact grid (420) and then pass through the electrical lead (150). As shown, a lead housing (500) couples the electrical lead (150) to the photovoltaic cell (200). According to one exemplary embodiment, the lead housing (500) is configured to weather proof the photovoltaic cell (200) and conductors (210) while securing the interface between the photovoltaic cell and the electrical lead (150). According to one exemplary embodiment, the lead housing (510) is made of an epoxy resin, a polymer material, or some other waterproof material configured to encapsulate the photovoltaic cell (200). Additionally, as illustrated in FIG. 5, the lead housing (500) includes a vent member configured to allow for the release of heat and gas created by the photovoltaic cell (200). As is illustrated in FIG. 6, the exhaust released through the vent will be allowed to escape the resulting matrix of panels via the lead channel (310). Alternatively, the photovoltaic cell may be vented through the casing of the electrical lead (150).

FIG. 6 illustrates a side cross-sectional view illustrating the placement of the present solar panel system on the roof of a structure, according to one exemplary embodiment. As illustrated in FIG. 6, the exemplary panels (130) are fastened to the roof (120) of a house or other structure via a fastener (600) such as a nail passing through the flashing (140) portion of the structure. As illustrated, the assembled matrix (610) includes an overlap of the panels on the proximal side of the upper most panel to create a shingle effect. According to one exemplary embodiment, this shingled effect will create a weather tight barrier between the panel matrix (610) and the roof of the structure. Additionally, as illustrated in FIG. 6, the electrical lead (150) is able to pas through the lead channels (310) of the upper-most panels (130).

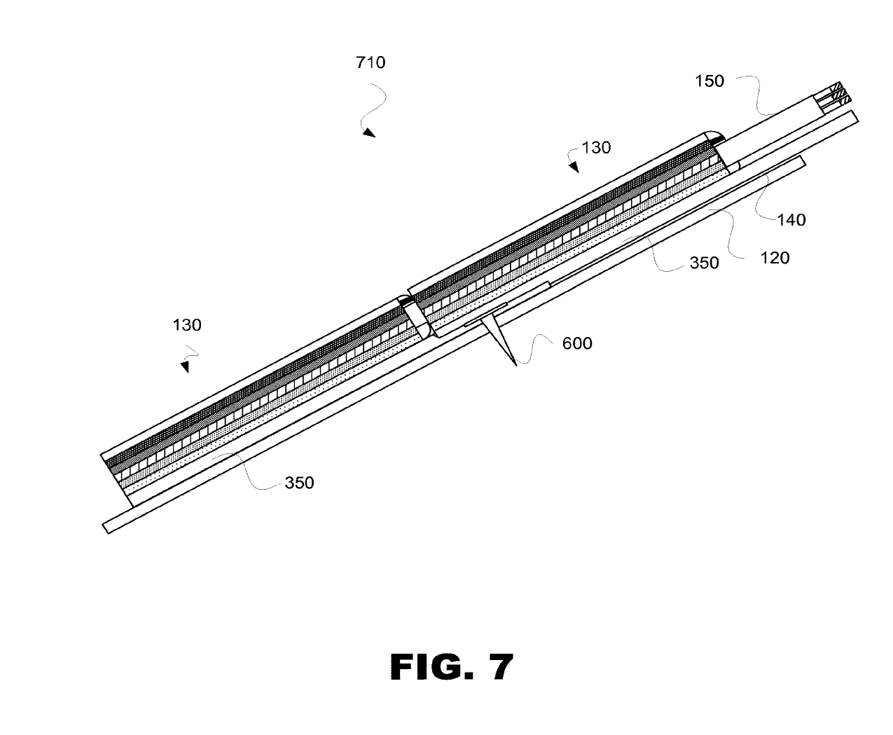

FIG. 7 illustrates an alternative exemplary configuration for placing the present solar panel system on the roof of a structure. According to the exemplary embodiment illustrated in FIG. 7, the assembled matrix (710) includes the exemplary panels (130) butted against each other with the flashing (140) overlapping to create a water barrier. According to this exemplary embodiment, the flashings (140) form a weather proof membrane on the surface of the roof (120) without overlapping the actual panels (130) themselves. Rather, the flashings (140) overlap and form the barrier.

While the present exemplary system has been described in the context of a generic silicon PV cell, any number of photo voltaic cell structures may be incorporated by the present exemplary system and method including, but in no way limited to, monocrystalline silicon cells, multicrystalline silicon cells, micromorphous silicon cells, thick film silicon cells, amorphous silicon cells, cadmium telluride (CdTe) based cells, copper indium diselenide (CIS) based cells, inverted metamorphic multi junction solar cells, and the like.

As noted above, the present exemplary system may be manufactured to custom fit the roof of a building or other structure. Alternatively, a number of non-functioning panels may be formed and incorporated on the roof of a house or building to allow for use of the present system without design manufacturing. Specifically, according to one exemplary embodiment, each of the above-mentioned exemplary panels (130) may be manufactured according to a standard range of sizes, each panel having the flashings (140) configured to overlap and form the weather proof membrane or barrier. However, during installation, when the contractor is presented with less than a standard area to cover and there is not a standard size panel available for use, or if a valley or exhaust pipe is encountered, a solar blank may be used. According to this exemplary embodiment, the solar blank panels are non-functioning panels having a back surface entirely covered with weather proof adhesive and including the previously explained flashings (140). According to this exemplary embodiment, when a non-uniform area is presented, the non-functioning panel may be cut to fit the non-uniform area, while maintaining the weather-proof barrier. Consequently, irregular shaped surfaces may benefit from the present exemplary system and method without the need for custom manufacturing.

### Alternative Embodiment

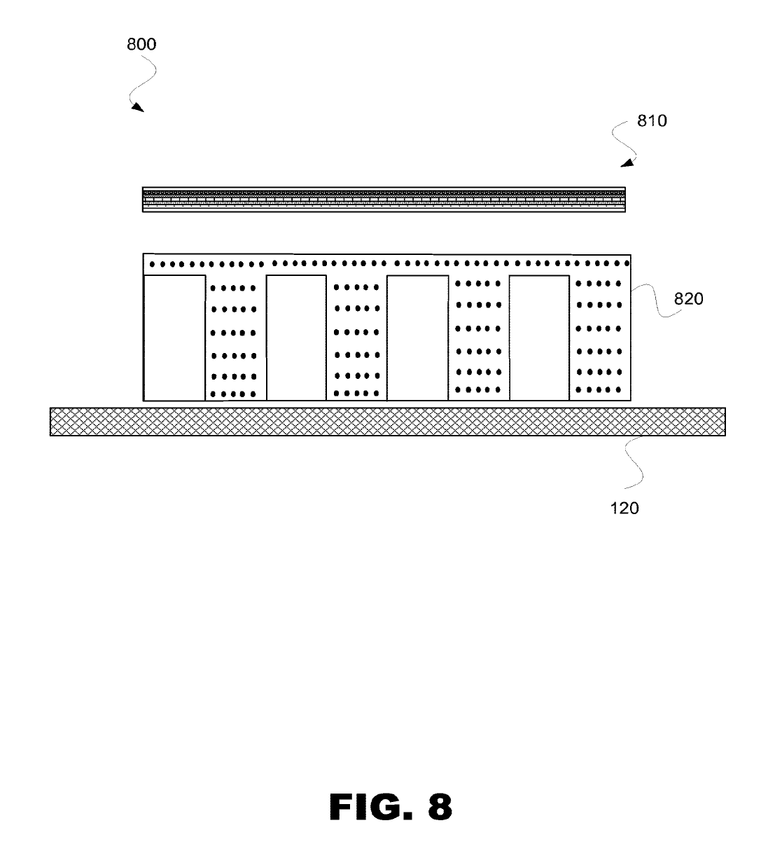

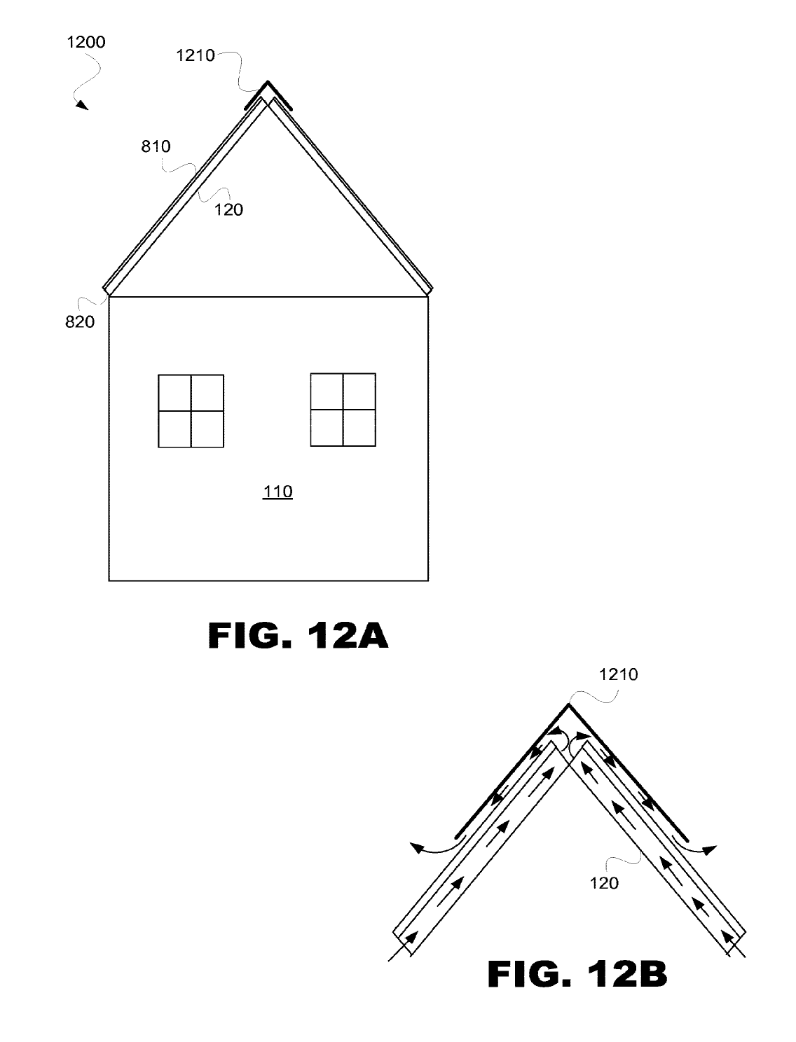

According to one exemplary embodiment, the back surface (350) and the associated lead channels (310) may be replaced by alternative structural members. Specifically, as illustrated in FIG. 8, a frameless panel (810) may be formed with sufficient structural integrity and sized sufficient to be supported by a vent sheet (820) that is configured to be placed directly on the roof (120) of a house or other structure. According to this alternative embodiment, the combination of the frameless panel (810) along with the vent sheet (820) provides a whole roof system (800) that facilitates electrical generation via the collection of solar energy, while maintaining a cool roof temperature. According to one embodiment, the vent sheet (820) receives and houses the frameless solar panel (810), while providing sufficient ventilation for cooling, as will be described below with reference to FIGS. 12A and 12B.

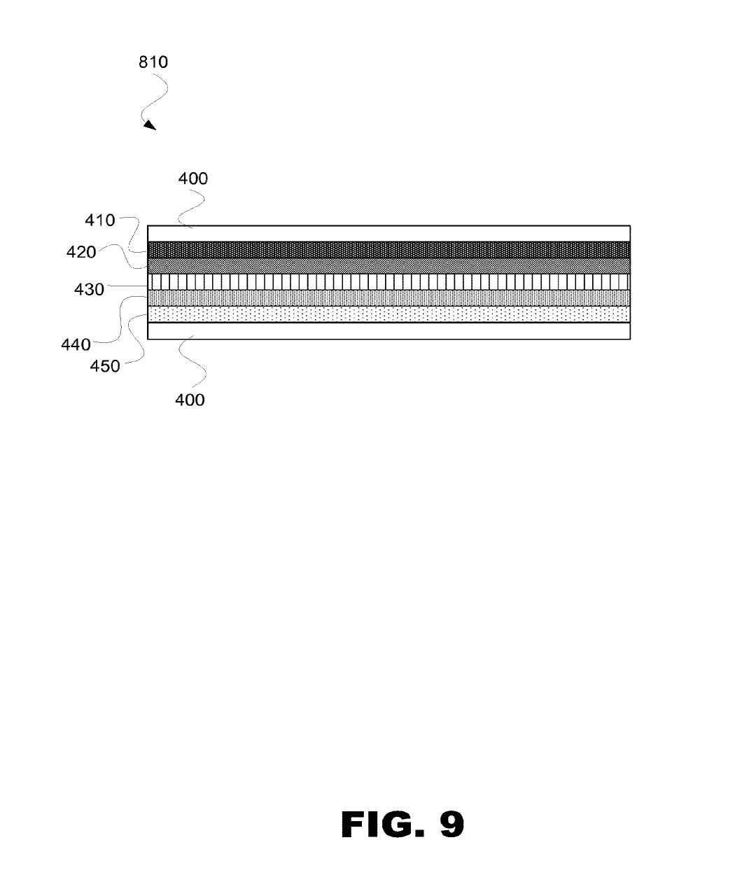

Turning now to FIG. 9, the exemplary frameless panel (810) is illustrated including both a top and a bottom glass (400) sandwiching the photovoltaic cell (200). According to one exemplary embodiment, similar to that illustrated in FIG. 4, the frameless panel (810) includes, but is in no way limited to a semiconductor laminated or otherwise adhered to a glass layer (400), the semiconductor having a back contact (450), a p-type semiconductor (440), an n-type semiconductor (430), a contact grid (420), an anti-reflective coating (410), and a cover glass substrate (400). According to one exemplary embodiment, the p-type semiconductor (440) and the n-type semiconductor (430) are separated by a P-N junction absorber layer (not shown).

According to the exemplary embodiment illustrated in FIG. 9, When the holes and electrons mix at the junction between N-type and P-type silicon, neutrality is disrupted and free electrons on the N-type semiconductor (430) cross to the p-type semiconductor (440) until an electric field separating the two sides. This electric field acts as a diode, allowing (and even pushing) electrons to flow from the P-type semiconductor (440) to the N-type semiconductor (430) creating an electric field acting as a diode in which electrons can only move in one direction. When light, in the form of photons, hits the frameless panel (810), its energy frees electron-hole pairs. Each photon with enough energy will normally free exactly one electron, and result in a free hole as well. If this happens close enough to the electric field, or if free electron and free hole happen to wander into its range of influence, the field will send the electron to the N-type semiconductor (430) and the hole to the P-type semiconductor (440). This causes further disruption of electrical neutrality, and if we provide an external current path, electrons will flow through the path to their original side, the P-type semiconductor (440), to unite with holes that the electric field sent there, doing work along the way. The electron flow provides the current, and the cell's electric field causes a voltage. With both current and voltage, power is produced.

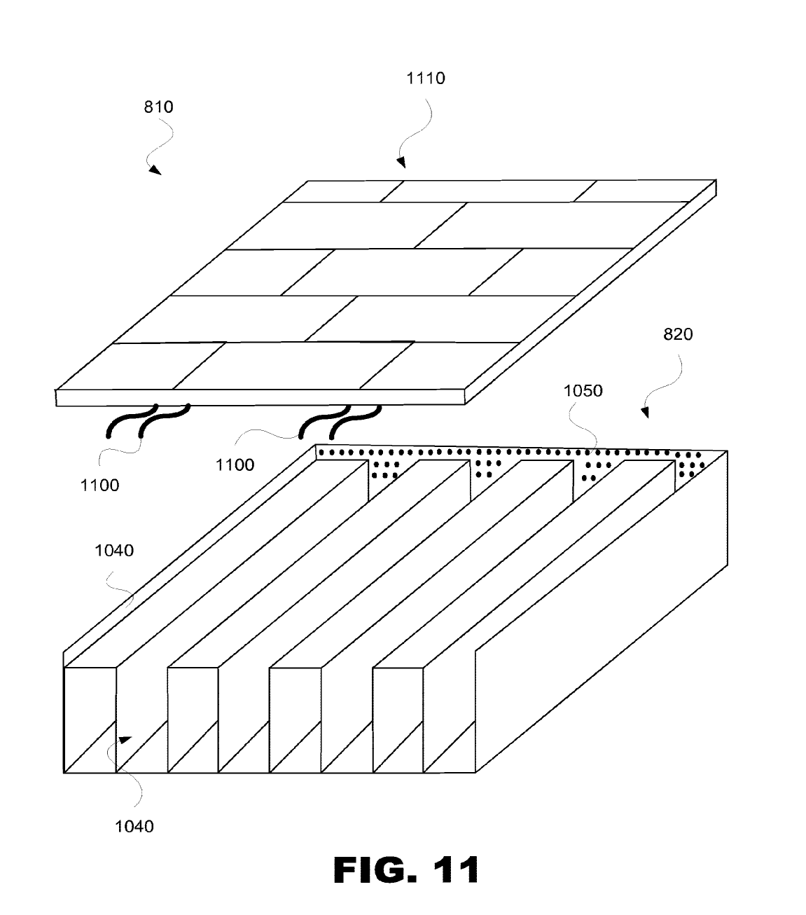

The back contact (450) and the contact grid (420) are formed to capture the power and transmit it, via a number of electrical leads (1100) to a power storage location (not shown). Additionally, as silicon is a very shiny material, it is very reflective. Since photons that are reflected can't be used by the cell, the antireflective coating (410) is applied to the top of the frameless panel (810) to reduce reflection losses. Additionally, the cover glass (400) is placed on the top if the frameless panel (810) in order to protect the panel from the elements. According to one exemplary embodiment, the cover glass (400) is processed such that its top view of the panel (130) is substantially similar to a traditional 30 year asphalt shingle. Particularly, as illustrated in FIG. 11, a repeating shingle pattern (1110) my be etched, painted, or otherwise formed on either side of the cover glass (400) or as an independent layer to provide mimic the appearance of traditional 30 year asphalt shingles. According to this exemplary embodiment, the etched or otherwise formed pattern is configured to permit the passage of photons to the frameless panel (810) while camouflaging the presence of the entire roof system (800) to discourage vandalism.

As noted above, the asphalt shingle appearance may be provided to the cover glass (400) via any number of surface treatment methods including, but in no way limited to, etching, painting, and the like. Similarly, the appearance may be conveyed by a separate and independent layer formed as a part of the frameless panel (810). According to one exemplary embodiment, the elimination of the frame may be accomplished by laminating or otherwise adhering all of the layers of the frameless panel (810) and the top and bottom glass (400). Once constructed, a plurality of panels (130) including photovoltaic cells (200) is placed in series and parallel to achieve useful levels of voltage and current that is transmitted through the electrical lead (150).

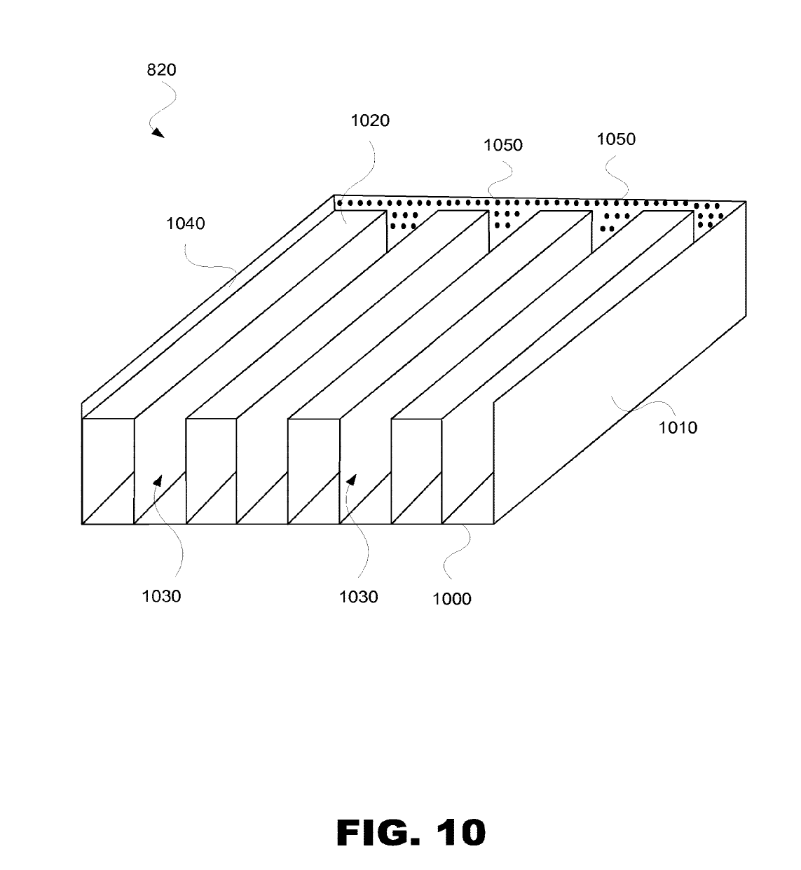

FIG. 10 further illustrates the features of the exemplary vent sheet (820), according to one exemplary embodiment. As shown, the exemplary vent sheet (820) includes a base (1000), at least three side walls (1010) defining a retention lip (1040) and defining at least one vent (1050) formed in at least one of the side walls (1010). Additionally, a plurality of ventilation channels (1030) are defined in the vent sheet (820) by the support pillars (1020) organized on the base (1000) within the side walls (1010). Further details of each component of the exemplary vent sheet (820) will be described below with reference to FIGS. 10 and 11.

As mentioned above, the exemplary vent sheet (820) includes a base (1000) that interfaces with the roof (120) of the structure that the entire roof system (800) is being secured to. According to this exemplary embodiment, the base and side walls (1010) may be formed of any number of materials including, but in no way limited to, iron, stainless steel, aluminum, copper, polymers, composites, and the like. Additionally, according to one exemplary embodiment, the base (1000) may include a flashing system, as described above, to form a moisture barrier between the entire roof system (800) and the roof (120) of the structure being secured to.

As shown in both FIGS. 10 and 11, the side walls (1010) are coupled to the base (1000) and extend vertically from the base to a height slightly above the most vertical point of the support pillars (1020) to form a retention lip (1040). The retention lip (1040) may be formed to retain a frameless panel (810) when inserted and supported by the vent sheet (820), as illustrated in FIG. 11. According to one exemplary embodiment, the retention lip (1040) has a height substantially equal to the thickness of the frameless panel (810).

As also illustrated in FIGS. 10 and 11. At least one vent (1050) is formed in at least one side wall (1010) when three or more sidewalls form the vent sheet (820). During installation, the exemplary vent sheets (820) are secured to the roof (120) of a house or other structure and form a base for a layer of frameless panels (810). The vent sheets (820) are oriented such that the ventilation channels (1030) defined by the support pillars (1020) interact. This allows for the flow of atmospheric air beneath the frameless panels (810), thereby cooling the panels. The inclusion of at least one vent (1050) in at least one side wall (1010) provides for a flow of air between adjacent vent sheets (820), thereby forming a networked flow of cooling air to maintain the roof (120) at an acceptable temperature.

Continuing with FIGS. 10 and 11, the exemplary vent sheet (820) further includes a plurality of support pillars (1020) disposed within the side walls (1010) and coupled to the base (1000). As illustrated, the support pillars (1020) may be formed as rectangular channels defining a plurality of ventilation channels (1030). While the present exemplary embodiment is illustrated as including a plurality of rectangular support pillars (1020) having substantially the same vertical height, the support pillars (1020) may assume any number of cross-sectional shapes including, but in no way limited to, cylinders, spheres, and the like. Regardless of the geometric shape of the support pillars (1020), the relative height of the support pillars (1020) is substantially consistent to form datum points that contact and support the frameless panel (810) when received within the vent sheet (820).

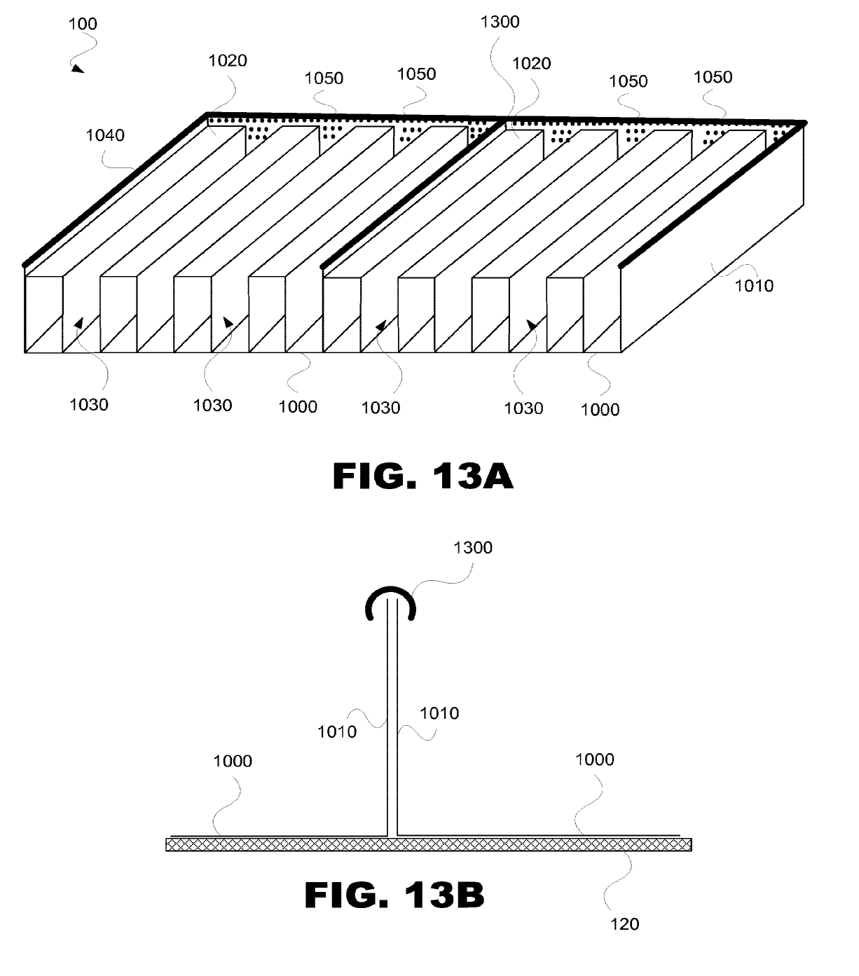

As mentioned above, the space between the support pillars (1020) create ventilation channels (1030) that may serve multiple purposes in the present exemplary configuration. According to one exemplary embodiment, the electrical leads (1100) formed on the frameless panels (810) are disposed in the ventilation channels. Additionally, should any moisture pass through the gaps between the vent sheet (820) and the frameless panels (810), it will collect in the ventilation channels (1030) and be routed off the roof (120). Additionally, in order to prevent moisture from passing between the sidewalls (1010) of adjacently placed vent sheets (820), a wall coupler (1300) may be placed above adjoining sidewalls, as illustrated in FIGS. 13A and 13B. As illustrated, the wall coupler (1300), which may be made of any moisture resistant material including, but not limited to, a polymer, metal, and the like, seals the space between adjacent sidewalls (1010) to create a vapor barrier between interlocked adjacent vent sheets, similar to a metal roof. While the wall coupler (1300) is illustrated as a separate coupling member, it may be formed as an integral part of each or selective sidewalls (1010).

As noted above, the shingle pattern (1110) is formed on each frameless panel (810) to give the present entire roof system (800) the appearance of traditional shingles. While the present exemplary system is described as assuming the pattern of traditional 30 year shingles, the shape, color, and/or surface finish of the frameless panels (810) may alternatively be modified to assume the shape and appearance of any number of roofing structures including, but in no way limited to, shingles, metal roofing, zinc, shingles, copper, slate, rubber, and the like.

As noted above, not all roofs are symmetrical in size and/or shape. Consequently, a number of blank panels may be formed for inclusion in the present entire roof system (800). According to this exemplary embodiment, when a traditionally sized or shaped frameless panel (810) will not fit within the desired space (such as in the valley of a roof), a blank may be inserted into a modified vent sheet. The blank may be constructed to include a top and bottom glass layer, a non-functioning center, and a shingle pattern (1110) to match the functional frameless panels (810). In this manner, the blanks may be cut to fit the desired area while maintaining the vapor barrier and consistent look of the entire roof system.

FIGS. 12A and 12B further illustrate the assembly (1200) of the entire roof system (800), according to one exemplary embodiment. As noted above, the vent sheets (820) are secured to the roof (120) of a house (110) or other structure and may form a vapor barrier for the roof (120). Once installed, the frameless panels (810) are inserted and secured in the vent sheets (820). According to one exemplary embodiment, a top cap (1210) is installed along any ridge line where the vent sheets (820) come together. As illustrated, the top cap (1210) is mounted along the ridge line above the vent sheets (820) sufficient to form a vent gap between the vent sheets and the top cap. As illustrated in FIG. 12B, cold or ambient air is routed through the ventilation channels (1030) of the vent sheets, thereby cooling the frameless panels (810). As illustrated by the arrows of FIG. 12B, when the air reaches the peak of the roof (120), the air encounters the top cap (1210) and exits through the gap between the top cap and the vent sheets (820). In this manner, the top cap promotes ventilation, while preventing rain, snow, and debris from reaching the roof (120). According to the present exemplary embodiment, the top cap (1210) may be made out of any number of appropriate materials including, but in no way limited to, metal, polymer, composite, and the like.

While the present alternative embodiment is described as incorporating a frameless panel (810) to be mounted on the exemplary vent sheets (820), it will be understood that any solar panel configuration with accompanying frames may be incorporated into the present support structure that forms a vapor barrier for a roof or other structure.

The photovoltaic cells may be made of any appropriate material. For example, a non-exhaustive list of materials that can be used may include crystalline silicon, monocrystalline silicon, amorphous silicon, graphene, other forms of carbon based materials, cadmium telluride, copper indium gallium selenide, gallium arsenide, or combinations thereof.

Solar cells made of graphene material are considered to be more conductive than the traditional silicon material used in commercial solar cells. Thus, a higher percentage of the released electrons can be captured and directed to an electric load. Graphene is made of a single layer of carbon atoms that are bonded together in a repeating pattern of hexagons. In some cases, the photovoltaic cells include a single layer of graphene. But, in other examples, the photovoltaic cells include multiple layers of graphene. For example, the photovoltaic cells may include two to thousands of layers of graphene. In one example, the photovoltaic cell includes four layers of graphene.

Graphene is also a transparent material. Thus, in embodiments where graphene is the photovoltaic material, more light can penetrate into the photovoltaic material to generate electricity. Further, the components underneath the graphene are also visible to a viewer.

In some examples, the photovoltaic material is made a layers of graphene sandwiched between layers of different material. For example, a single layer of graphene may be placed adjacent to a layer of molybdenum disulfide. The thickness of these two combined layers may be one nanometer thick. In some cases, the photovoltaic material may be made of multiple combined layers of the graphene and molybdenum disulfide sub-layers. This example, the molybdenum disulfide can be used to absorb light, while the graphene can be used to conduct the electrons.

Graphene sheets may be made with any appropriate manufacturing technique. In some examples, the graphene layers may be made by using tape to peel of sublayers of a carbon material until just one layer of carbon (graphene) is left. In other examples, the graphene sheets may be formed through a three dimensional printing technique. In other examples, the graphene sheets may be manufactured through a deposition process.

For example, graphene sheets may be made by depositing a graphene film made from methane gas on a nickel plate. A protective layer of thermoplastic may be laid over the graphene layer and the nickel underneath can then dissolved in an acid bath or through another method. Next, the plastic-coated graphene may be attached to a flexible polymer sheet or another type of sheet. The sheer may then be incorporated into a photovoltaic cell. In some examples, graphene/polymer sheets 150 square centimeters or less.

A roof decoration may be disposed under the transparent photovoltaics cells. In this example, the roof decoration is viewable through the transparent photovoltaic cells. The roof decorations may resemble the appearance of more conventional roofing materials. Thus, an observer viewing the structure with the photovoltaic cells and roofing structure may view a roof that appears to be more conventional. In some examples, the roof decoration causes the observer to believe that he or she is looking at a conventional roof. In these examples, the transparent photovoltaic cells are adjacent to each other and abutted against each other to form junctions. A sealing material may be disposed between the junctions so that the layer of photovoltaic cells across the roof form a vapor barrier. In some cases, the sealing material is transparent either due to the sealing material's natural characteristics or the limited amount of the sealing material used to create the seal. Thus, the junctions between the transparent photovoltaic materials may not be visible to an observer, especially in those circumstances where the observer is spaced away at a distance from the roof, such as on ground level or looking at the roof from a farther distance.

Any appropriate type of roof decoration may be used with the photovoltaic cell. The roof decorations may resemble any appropriate type of roof. For example, the roof decoration may resemble tiles, Terracotta tiles, thatching, straw, leaves, metal sheeting, stone, turf, brick, vegetation, sod, slate, another type of roof material, or combinations thereof. In other examples, the roof decoration may be holiday themed, entertainment themed, advertising material, a nature scene, another type of decoration, or combinations thereof.

The seals between the photovoltaic cells prevent rain and snow from entering underneath the photovoltaic cells in the mounting structure. Further, the seals also prevent the snow melt induced by the heating system from getting underneath the photovoltaic cells. Thus, as the snow melts from the heating circuit, the snow flows down from the upper surface of higher photovoltaic cells on the roof to the upper surfaces of the downstream photovoltaic cells on the roof until the snow melt reaches the bottom edge of the most downstream photovoltaic cell and the snow melt slides or drips off of the roof.

In some examples, the vapor barrier formed by the photovoltaics cells may include some portions that are not photovoltaic. In these examples, the non-photovoltaic portions may also be made of a transparent material and include the roof decoration underneath. These non-photovoltaic portions may also be adjacent to and abutted against the photovoltaic cells in the mounting structures. Further, the non-photovoltaic portions may be held in the mounting structure in a similar manner as the photovoltaic cells are in the mounting structure.

In some instances, the non-photovoltaic portions are included to reserve a location on the roof for future projects. For example, the non-photovoltaic portions may be located over maintenance areas. In other examples, the non-photovoltaic portions may be placed at locations where a chimney, an antenna, a communication device, a wind vane, another type of device, or combinations thereof are planned to be installed at a future date.

The non-photovoltaic portions may be made of a material that has a lower melting temperature than the photovoltaic cells. In this circumstance, if the structure were to catch fire, the non-photovoltaic portions of the roofing structure may melt first. This may help vent smoke and heat out of the building through the opening created when the non-photovoltaic material melted away. In one embodiment, a roof profile matching shaped cap may be located along the ridge of the roof where a first side of the cap overlays the roof on a first side of the ridge and a second side of the cap overlays the roof on a second side of the ridge. The cap over the ridge may be the highest point on the roof, or at least the highest point for a portion of the roof where heat from a fire will accumulate as the heated air from the fire travels through the vents incorporated into the mounting structure. The cap may have a lower melting temperature than the photovoltaic cells. Thus, in the event of a fire, the cap may melt at a lower temperature than the photovoltaic cells. As a result, the cap will be removed at a lower temperature which may allow the smoke and heat from the fire to evacuate from the house.

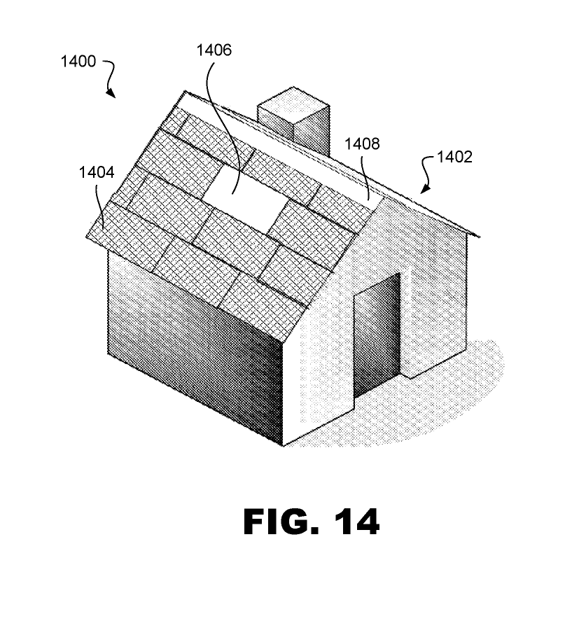

FIG. 14 depicts an example of a solar panel system (1400) incorporated onto a roof structure (1402). In this example, the solar panel system (1400) includes multiple panels (1404) with a photovoltaic material. In addition to the panels with photovoltaic material, the solar panel system also includes panels with non-photovoltaic cells (1406). These panels without photovoltaic material can be place holders that make available roof space for functions other than harvesting energy. For example, the panels without photovoltaic material may be located where an antenna, satellite equipment, chimney, wind vane, or other types of equipment is expected to be installed onto the roof in the future.

The cells with non-photovoltaic material may also be made of material that has a lower melting temperature than the cells with photovoltaic material. In this example, the cells with the non-photovoltaic material may melt during a fire, which may allow heat, smoke, etc. to escape through the opening created when the cells having the non-photovoltaic melts. This may reduce the heat at the undersides of the cells with photovoltaic material and help preserve these photovoltaic cells while the emergency personnel are trying to extinguish the fire.

In addition to the cells (1406) with non-photovoltaic material. A cap (1408) may be positioned along the length of a ridge of the roof structure. The cap (1408) may also be made of a material that melts at a temperature lower than the photovoltaic cells. In this example, the cap (1408) may melt creating an opening out of which smoke and heat can escape from the structure. While this example depicts the cells with photovoltaic material appearing different from the cells without photovoltaic material, the cells with and without photovoltaic material may have the same appearance. For example, both the cells with and without photovoltaic material may be transparent and the roof decoration subjacent to the cells may be visible through the transparent material.

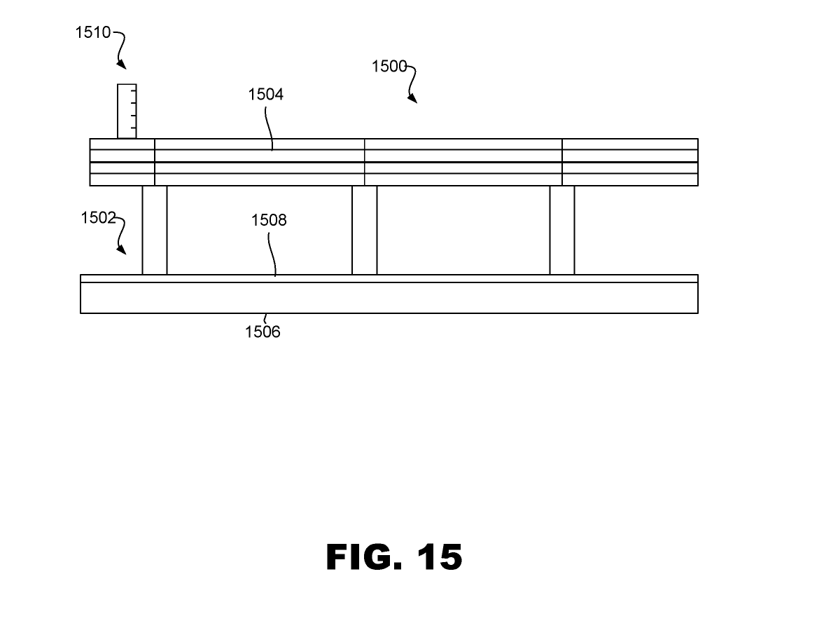

FIG. 15 depicts an example of the photovoltaic cell (1500) and the mounting structure (1502). In this example, the photovoltaic cell (1500) is made of multiple layers (1504) of graphene. Each cell is abutted against another cell, which forms a seal between the cells. The mounting structure (1502) includes walls that support the cells and that space the photovoltaic cells a distance away from the roof (1506). The roof, walls, and underside of the photovoltaic cells define a vent that can circulate air or vent gases. A water proof layer (1508) is attached to the roof (1506). Thus, the cells form a first water proof layer that prevents moisture from getting to the roof, and the water proof layer also forms a second vapor barrier that prevents moisture from getting to the roof.

Also, depicted in FIG. 15 is a sensor gauge (1510) attached to the cells. The sensor gauge may measure the amount of snow on the photovoltaic cells. As the snow accumulates on the cells, the snow blocks light from entering the sensor gauge. In response to determining that a layer of snow exists on the cells, the current in the photovoltaic cells can be reversed to create heat, or an independent circuit can be activated to produce a heating effect to melt the snow.

In conclusion, the present exemplary system and method for forming a solar panel system includes manufacturing solar panel sheets via thin film solar technology or other photovoltaic cell forming process that include a flashing overlap and a non-dry adhesive located on the bottom surface of the sheets such that the solar panel sheets form a moisture barrier on the roof while providing a renewable solar energy source. Alternatively, additional mounting systems are disclosed for forming a vapor barrier, while providing a cool roof system. According to one exemplary embodiment, the solar panel system that forms a moisture barrier on the roof of a structure includes a non-glare surface treatment to provide the appearance of standard 30 year shingles. Additionally, in another exemplary embodiment, the solar panel system includes a temperature/pressure/light transmissibility sensor system configured to notify a homeowner when the solar panel system is dirty, obscured, or should be changed to reverse current mode to melt snow or ice buildup.

The preceding description has been presented only to illustrate and describe exemplary embodiments of the present system and method. It is not intended to be exhaustive or to limit the system and method to any precise form disclosed. Many modifications and variations are possible in light of the above teaching. It is intended that the scope of the system and method be defined by the following claims.

What is claimed is:

1. An apparatus comprising:
a transparent photovoltaic cell;
a roof decoration located under and viewable through the transparent photovoltaic cell; and
a mounting frame sized to receive said photovoltaic cell and the roof decoration;
wherein said mounting frame is configured to be securely fastened to a roof of a structure.

2. The apparatus of claim 1, the roof decoration resembles tile.

3. The apparatus of claim 1, wherein the roof decoration resembles roof singles.

4. The apparatus of claim 1, wherein the roof decoration resembles thatching.

5. The apparatus of claim 1, wherein said photovoltaic cell further comprises a gauge sensor.

6. The apparatus of claim 5, wherein the gauge sensor measures an amount of snow on the transparent photovoltaic cell.

7. The apparatus of claim 6, further comprising a heating system that melts snow on the transparent photovoltaic cell in respond to a measurement obtained with the gauge sensor.

8. The apparatus of claim 1, wherein said mounting frame further comprises:
a base;
a plurality of side walls coupled to said base and extending vertically from said base; and
a plurality of support structures formed on said base, said plurality of support structures being configured to support said photovoltaic cell above said base.

9. The apparatus of claim 8, wherein said plurality of support structures define at least one vent channel configured to direct air beneath said photovoltaic cell.

10. The apparatus of claim 9, wherein said photovoltaic cell further comprises a plurality of leads coupled to said photovoltaic cell,
wherein the leads are disposed in said at least one vent channel when said apparatus is assembled.

11. The apparatus of claim 9, further comprising a wall coupler disposed on a top surface of a plurality of sidewalls to seal adjacent side walls.

12. The apparatus of claim 9, wherein said plurality of support structures formed on said base comprise a rectangular cross-section.

13. The apparatus of claim 9, wherein said plurality of support structures formed on said base comprise a circular cross-section.

14. An apparatus comprising:
a first transparent photovoltaic cell;
a second transparent photovoltaic cell adjacent to and abutted against the first transparent photovoltaic cell forming a junction between the first transparent photovoltaic cell and the transparent photovoltaic cell;
a sealing material disposed within the junction;
a roof decoration located under and viewable through at least one of the first transparent photovoltaic cell and the second transparent photovoltaic cell;
a mounting frame sized to receive said photovoltaic cell, wherein said mounting frame further includes a base, a plurality of side walls coupled to said base and extending vertically from said base, and a plurality of support structures formed on said base, said plurality of support structures being configured to support said photovoltaic cell above said base;
wherein said plurality of support structures define at least one vent channel configured to direct air beneath said photovoltaic cell;
wherein said mounting frame is configured to be securely fastened directly to a roof of a structure and form a vapor barrier on said roof.

15. The apparatus of claim 14, wherein a non-photovoltaic spacer is adjacent to and abutted against another side of at least one of the first transparent photovoltaic cell and second transparent photovoltaic cell, wherein the non-photovoltaic spacer comprises a lower melting temperature than the first transparent photovoltaic cell.

16. The apparatus of claim 15, wherein the non-photovoltaic spacer is positioned over a ridge of the roof.

17. The apparatus of claim 14, wherein said photovoltaic cell further comprises a gauge sensor.

18. The apparatus of claim 17, wherein the gauge sensor measures an amount of snow on the transparent photovoltaic cell.

19. The apparatus of claim 17, further comprising a heating system that melts snow on the transparent photovoltaic cell in respond to a measurement obtained with the gauge sensor.

20. An apparatus comprising:
a first transparent photovoltaic cell;
a second transparent photovoltaic cell adjacent to and abutted against the first transparent photovoltaic cell forming a junction between the first transparent photovoltaic cell and the transparent photovoltaic cell;
a sealing material disposed within the junction;
a roof decoration located under and viewable through at least one of the first transparent photovoltaic cell and the second transparent photovoltaic cell;
a mounting frame sized to receive said photovoltaic cell, wherein said mounting frame further includes a base, a plurality of side walls coupled to said base and extending vertically from said base, and a plurality of support structures formed on said base, said plurality of support structures being configured to support said photovoltaic cell above said base;
a non-photovoltaic spacer is adjacent to and abutted against another side of at least one of the first transparent photovoltaic cell and second transparent photovoltaic cell, wherein the non-photovoltaic spacer comprises a lower melting temperature than the first transparent photovoltaic cell;
the non-photovoltaic spacer is positioned over a ridge of a roof;
the photovoltaic cell further comprises a gauge sensor;
the gauge sensor measures an amount of snow on the transparent photovoltaic cell; and
a heating system that melts snow on the transparent photovoltaic cell in respond to a measurement obtained with the gauge sensor;
wherein said plurality of support structures define at least one vent channel configured to direct air beneath said photovoltaic cell;
wherein said mounting frame is configured to be securely fastened directly to the roof of a structure and form a vapor barrier on said roof.
